(19) United States
(12) Patent Application Publication
(10) Pub. No.: US 2023/0311050 A1
(43) Pub. Date: Oct. 5, 2023

(54) DUAL FILTRATION AND AUTO CLEANSING MECHANISM

(71) Applicant: Carrier Corporation, Palm Beach Gardens, FL (US)

(72) Inventors: Saurabh Kumar Sinha, Hyderabad (IN); Ankit Sarin, Hyderabad (IN); Srinivasa Reddy Pilli, Hyderabad (IN); Arvind Kumar Madhavapeddi, Hyderabad (IN)

(21) Appl. No.: 18/191,127

(22) Filed: Mar. 28, 2023

Related U.S. Application Data
(60) Provisional application No. 63/324,915, filed on Mar. 29, 2022.

(51) Int. Cl. B01D 46/682; B01D 46/22; B01D 46/681; B01D 46/46; F24F 8/108; F24F 13/28

(52) U.S. Cl. CPC B01D 46/682; B01D 46/22; B01D 46/46; B01D 46/681; F24F 8/108; F24F 13/28; B01D 2279/50

(57) ABSTRACT

A cleanable filtration system for an air conditioning system includes a continuous filter positionable adjacent to an inlet opening in the air conditioning system and a drive system operably coupled to the continuous filter to move the continuous filter relative to the inlet opening. A cleaning jet is positioned to spray a cleaning fluid on an adjacent portion of the continuous filter.

### CROSS-REFERENCE TO RELATED APPLICATIONS

This application claims the benefit of U.S. Application No. 63/324,915, filed Mar. 29, 2022, the contents of which are incorporated by reference herein in their entirety.

### BACKGROUND

Embodiments of the present disclosure relate to heating, ventilation, and air conditioning systems, and more particularly to a device for cleaning a filter at an air intake of a heating, ventilation, and air conditioning systems.

Heating, ventilation, and air conditioning (HVAC) systems, such as that deliver forced air to an area being conditioned for example, commonly filter the air that passes through the system. The most common types of filters are simple mechanical filters that remove particulates from the air stream as it flows therethrough. A chemical filtration capability can also be added by the insertion of certain materials such as carbon, to remove certain undesirable chemicals.

Over time, filters become clogged with dirt, dust, micro-organisms, and other impurities Because clogged filters inhibit the airflow through the HVAC system, and therefore the efficiency thereof, periodic cleaning or replacement of such filters is required. Manual cleaning of filters is tedious and time consuming. The life of the filter as well as the evaporator is also impacted based on the methods used during the cleaning procedure.

### BRIEF DESCRIPTION

According to an embodiment, a cleanable filtration system for an air conditioning system includes a continuous filter positionable adjacent to an inlet opening in the air conditioning system and a drive system operably coupled to the continuous filter to move the continuous filter relative to the inlet opening. A cleaning jet is positioned to spray a cleaning fluid on an adjacent portion of the continuous filter.

In addition to one or more of the features described herein, or as an alternative, in further embodiments the drive system further comprises a drive mechanism and at least one support operably coupled to the drive mechanism. The at least one support is mounted within an interior area defined by the continuous filter.

In addition to one or more of the features described herein, or as an alternative, in further embodiments the at least one support is frictionally engaged with the continuous filter.

In addition to one or more of the features described herein, or as an alternative, in further embodiments the at least one support includes a first support and a second support, and the first support is operably coupled to the drive mechanism.

In addition to one or more of the features described herein, or as an alternative, in further embodiments the second support is a passive support.

In addition to one or more of the features described herein, or as an alternative, in further embodiments comprising a housing having a hollow interior and a hole formed at a side of the housing such that the continuous filter extends through the hole, wherein the cleaning jet is positioned to spray the cleaning fluid on the continuous filter within the housing.

In addition to one or more of the features described herein, or as an alternative, in further embodiments comprising a cleaning brush positioned downstream from the cleaning jet relative to a path of movement of the continuous filter, wherein the cleaning brush is arranged in engagement with a surface of the continuous filter.

In addition to one or more of the features described herein, or as an alternative, in further embodiments comprising another cleaning brush positioned upstream from the cleaning jet relative to the path of movement of the continuous filter, wherein the another cleaning brush is arranged in engagement with the surface of the continuous filter.

In addition to one or more of the features described herein, or as an alternative, in further embodiments comprising a housing, wherein at least one of the cleaning brush and the another cleaning brush being arranged within an interior of the housing.

In addition to one or more of the features described herein, or as an alternative, in further embodiments the cleaning brush and the another cleaning brush are axially aligned.

In addition to one or more of the features described herein, or as an alternative, in further embodiments the cleaning brush and the another cleaning brush are axially offset.

In addition to one or more of the features described herein, or as an alternative, in further embodiments the continuous filter is formed from a mesh material.

According to an embodiment, an air conditioning system includes a cabinet having an inlet opening, a filter mounted in overlapping arrangement with the inlet opening, and a system for automatically cleaning the filter while the filter is mounted to the cabinet.

In addition to one or more of the features described herein, or as an alternative, in further embodiments the system for automatically cleaning the filter includes a housing mounted to the cabinet.

In addition to one or more of the features described herein, or as an alternative, in further embodiments the filter is a continuous filter and the system for automatically cleaning the filter further comprises a drive system operably coupled to the continuous filter to move the continuous filter relative to the inlet opening and a cleaning jet positioned to spray a cleaning fluid on an adjacent portion of the continuous filter.

According to an embodiment, a method of operating an air conditioning system includes automatically initiating a filter cleaning operation, driving a filter of the air conditioning system along a path of movement relative to a housing of the air conditioning system while the filter is connected to the air conditioning system, and spraying a cleaning fluid onto a portion of the filter as the filter is driven along the path of movement.

In addition to one or more of the features described herein, or as an alternative, in further embodiments initiating the filter cleaning operation occurs on demand.

In addition to one or more of the features described herein, or as an alternative, in further embodiments initiating the filter cleaning operation occurs based on a predetermined schedule.

In addition to one or more of the features described herein, or as an alternative, in further embodiments initiating the filter cleaning operation occurs based on a sensed parameter.

In addition to one or more of the features described herein, or as an alternative, in further embodiments initiating the filter cleaning operation occurs in response to one of artificial intelligence and a machine learning algorithm.

### BRIEF DESCRIPTION OF THE DRAWINGS

The following descriptions should not be considered limiting in any way. With reference to the accompanying drawings, like elements are numbered alike:

FIG. 1 is perspective view of an exemplary portion of a heating ventilation, and air conditioning (HVAC) system according to an embodiment;

FIG. 2 is a perspective cross-sectional view of the portion of the HVAC system of FIG. 1 taken along line 2-2 according to an embodiment;

FIG. 3 is a cross-sectional view of the portion of the HVAC system of FIG. 1 according to an embodiment;

FIG. 4 is a schematic diagram of a drive system of a cleanable filtration system according to an embodiment;

FIG. 5 is detailed view of FIG. 2 according to an embodiment;

FIG. 6 is a perspective view of another heating ventilation, and air conditioning (HVAC) system according to an embodiment;

FIG. 7 is a perspective cross-sectional view of a portion of the HVAC system of FIG. 6 according to an embodiment; and

FIG. 8 is another perspective cross-sectional view of a portion of the HVAC system of FIG. 6 according to an embodiment.

### DETAILED DESCRIPTION

A detailed description of one or more embodiments of the disclosed apparatus and method are presented herein by way of exemplification and not limitation with reference to the Figures.

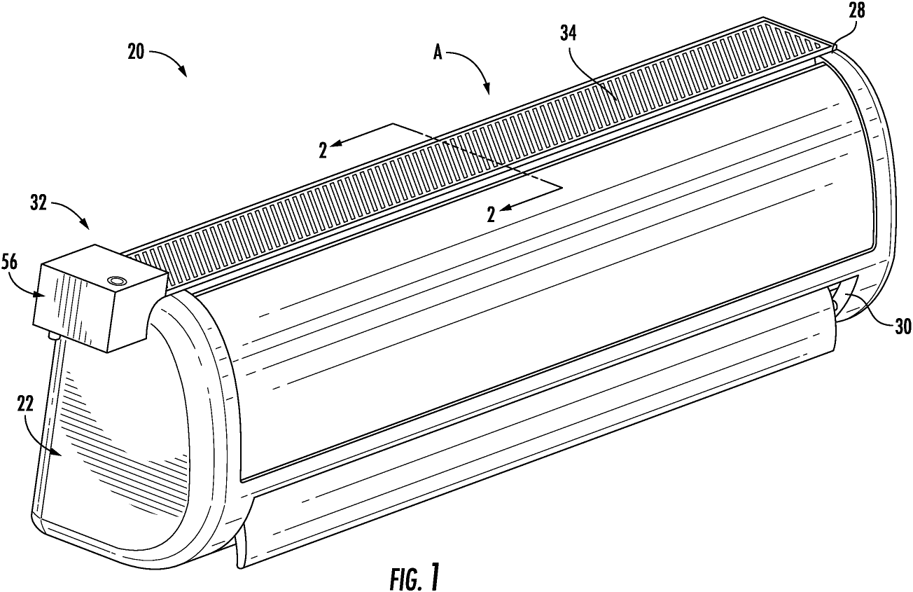

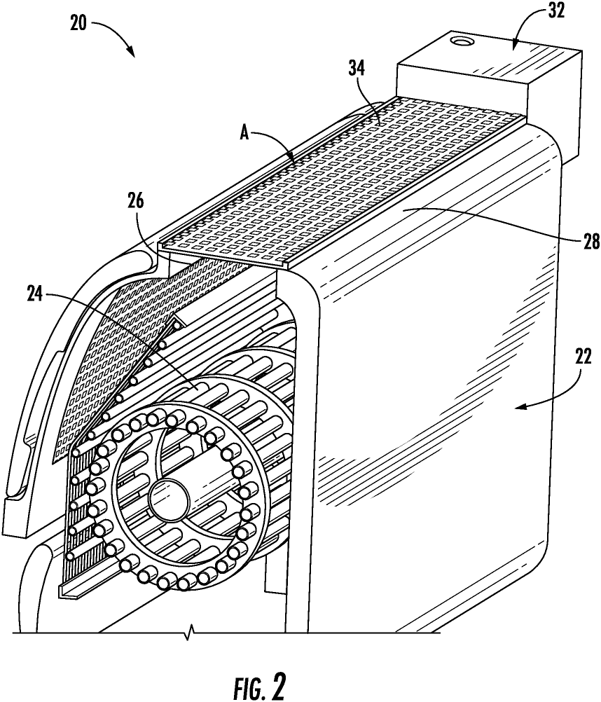

With reference now to FIGS. 1-2, an example of a portion of a heating ventilation, and air conditioning (HVAC) system is illustrated. In the illustrated, non-limiting embodiment, the portion is an air conditioning unit 20 of a residential split air conditioning system. As shown, the air conditioning unit 20 includes a housing or cabinet 22, such as for mounting to a wall. The cabinet 22 may contain a fan (not shown) and an evaporator 24 fluidly coupled to an outdoor compressor unit (not shown) by inlet and outlet refrigerant lines. The cabinet 22 includes an opening or inlet opening 26, such as near an upper surface 28 thereof, through which warm air from the ambient atmosphere is drawn. The air A is cooled as it passes over the evaporator 24 and is then exhausted via an outlet 30.

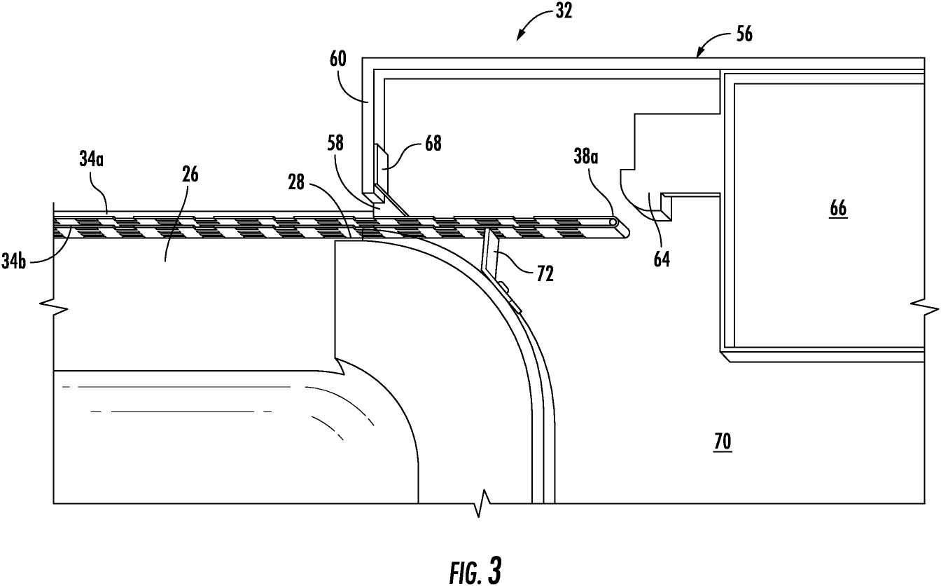

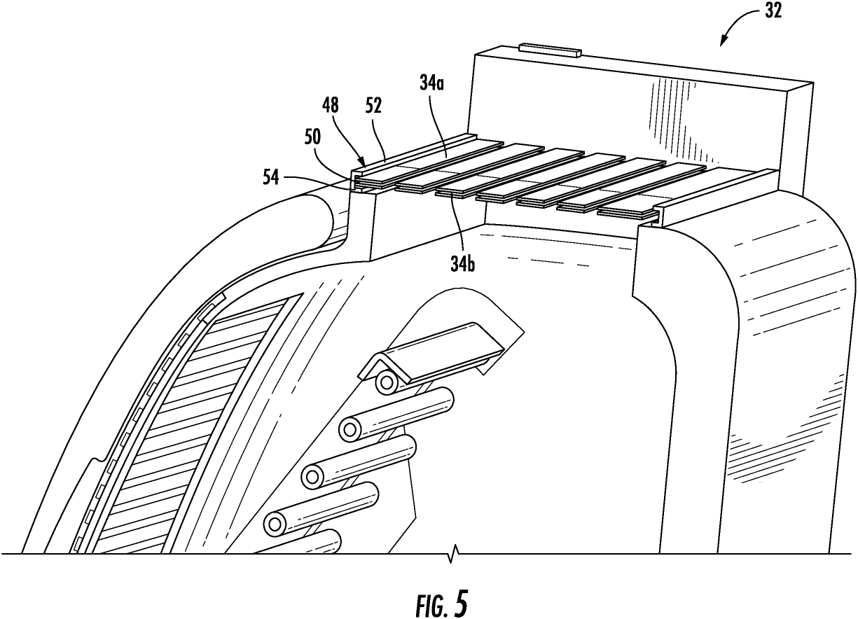

With continued reference to FIGS. 1 and 2 and further reference to FIGS. 3-5, in an embodiment, the air conditioning unit 20 includes a cleanable filtration system 32. As shown, the cleanable filtration system 32 includes a filter 34 arranged at or in overlapping arrangement with the opening 26. The filter 34 may extend over the entire length, or alternatively, over only a portion of the length of the inlet opening 26. The filter 34 may be formed from any suitable durable mesh material, including but not limited to a nylon for example. As best shown in FIG. 3, the filter 34 is formed as a continuous band or belt, and therefore does not have any ends. In an embodiment, the filter 34 is positioned such that the air flow A provided to the air conditioning unit 20 is configured to pass through both a first or upper portion 34a of the filter 34 and a second or lower portion 34b of the filter 34 before being conditioned. The air A flows through the first portion 34a and the second portion 34b of the filter 34 sequentially, and in some embodiments, the air A may pass directly from the first portion 34a to the second portion 34b of the filter 34.

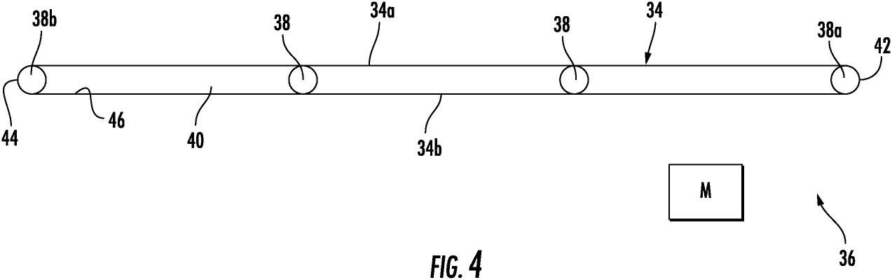

In an embodiment, the cleanable filtration system 32a includes a drive system 36 coupled to the continuous filter 34 and operable to drive the filter 34 relative to the cabinet 22 of the air conditioning unit 20. As shown, the drive system includes 36 one or more supports 38. such as rollers or sprockets for example, about which the filter 34 is mounted. In the illustrated, non-limiting embodiment, best shown in FIG. 4. a first support 38a is disposed within the interior area 40 defined by the continuous filter 34, such as between the first portion 34a and the second portion 34b near a first side 42 thereof, and a second support 38b is disposed within the interior area 40 such as between the first portion 34a and the second portion 34b near a second, opposite side 44 of the continuous filter 34. Additional supports 38 may be mounted within the interior area 40 at intervals over the axial length of the filter 34 to prevent the first, upper portion 34a of the filter 34 from sagging. However, embodiments that do not include these additional supports are also contemplated herein.

Rotation of one or more of the supports 38 is configured to drive rotation of the filter 34. In an embodiment, the one or more supports 38 and/or the inwardly facing surface 46 of the filter 34 arranged in contact with the one or more supports 38 includes a frictional surface resulting in frictional engagement therebetween. However, embodiments where the at least one support 38 has a drive feature, such as a plurality of teeth for example, configuration to intermesh with a plurality of openings formed in the filter 34 are also within the scope of the disclosure.

The at least one support 38 of the drive system 36 includes a motor driven support, which is also referred to herein as a “drive support.” A motor or another suitable drive mechanism, illustrated schematically at M. may be separate from and operably coupled to the drive support 38. such as via a rotatable shaft for example. However, in other embodiments, the motor M may be integrally formed or embedded within the support 38. In embodiments including a plurality of supports, a first support, such as support 38a for example, may be a drive support and a second support, such as support 38b for example, may be a passive support configured to rotate freely in response to engagement with the filter 34. In such embodiments, the drive support 38a may be operable to drive the filter 34 in both a first direction and a second direction. Embodiments where the drive system 36 includes multiple drive supports and/or no passive supports are also contemplated herein.

A passageway 48 operable as a guide rail may be formed in the portion of the cabinet 22 arranged at the sides of the filter 34. In the illustrated, non-limiting embodiment best shown FIG. 4, a rectangular groove 50 is formed between a first upper flange 52 and a second lower flange 54. The side of the filter 34 is positioned within the groove such that the upper and lower flange overlap with a portion of the filter 34. This overlap restricts vertical movement of the filter 34 relative to the cabinet 22 as the filter 34 is driven along its path of rotation.

The cleanable filtration system 32 may additionally include a housing 56 mounted to the cabinet 22 adjacent the filter 34. As shown, an opening or hole 58 is formed inside 60 of the housing 56 such that only a small portion of the filter 34. such as an end thereof, is arranged within the interior 62 of the housing 56. In an embodiment, a cleaning jet 64 is arranged within the interior 62 of the housing 56 and is operable to spray a stream of cleaning fluid over an adjacent portion of the filter 34. such as first side 42 for example, to remove particles of dirt, dust, and other debris from the filter 34. The cleaning fluid may, but need not include a disinfectant. The cleaning jet 64 is operated by a motor. The motor may be the same motor as used in the drive system 36, or alternatively, may be different therefrom. The cleanable filtration system 32 may include a tank or reservoir 66 arranged in fluid communication with the cleaning jet 64. The reservoir 66 may be configured to store a desired amount of cleaning fluid therein and may be removably connectable to the air conditioning unit 20. Alternatively, or in addition, the cleaning jet 64 may be fluidly coupled to another cleaning fluid source, which can be a filtered condensate within the air conditioning unit 20 or system and may be configured to receive a cleaning fluid therefrom on demand. In an embodiment, the cleaning fluid source is a condensate tray arranged within the air conditioning unit. In an embodiment, the dirt particles with debris and/or removed cleaning fluid is drained/exhausted into the condensate drain pipe without hampering the current drain system.

A first cleaning brush 68 may be mounted adjacent the opening 6.1 at the side of the housing 56. The first cleaning brush is positioned to engage the upper surface of the first portion 34A of the filter 34 to remove dust, and dirt particles therefrom. By positioning the first cleaning brush 68 within the interior 62 of the housing 56. the dust and dirt removed by the first cleaning brush 68 may be pushed into a collecting compartment 70 located underneath the filter 34 within the housing 56. However, embodiments where the first cleaning brush 68 is located at an exterior of the housing 56. or alternatively, at a location remote from the housing 56 are also contemplated herein.

Alternatively, or in addition to the first cleaning brush 68, another cleaning brush, such as a second cleaning brush 72, may be mounted downstream from the cleaning jet 64 relative to the path of movement of the filter 34. Although the first and second cleaning brushes are vertically offset from one another, embodiments where the brushes 68, 72 are aligned are also within the scope of the disclosure. The second cleaning brush 72 is positioned to engage the lower surface of the second portion 34B of the filter 34 (this surface was previously the upper surface of the first portion 34A) to remove any remaining particles and excess water droplets or cleaning fluid therefrom. By positioning the second cleaning brush 72 within the interior 62 of the housing 56. the debris and/or water removed by the second cleaning brush 72 may also be pushed into the collecting compartment 70 of the housing 56. It should be understood that the cleanable filtration system 32 illustrated and described herein is intended as an example only and that a cleanable filtration system 32 having another configuration is also within the scope of the disclosure.

The cleanable filtration system 32 may be configured to continuously or intermittently perform a filter cleaning operation to clean the filter 34. In embodiments where the cleanable filtration system 32 is operable intermittently, the cleansing may be done at a predetermined schedule or time intervals and/or may be performed on demand or based on AI, a machine learning algorithm, or the like. In an embodiment, a user may be operable to initiate a cleaning cycle, such as by pushing a button. In another embodiment, the cleanable filtration system 32 may include a sensor operable to monitor one or more parameters associated with operation of the filter 34. In an embodiment, the sensed parameter is the indoor air quality of the air surrounding the air conditioning unit 20. In another embodiment, the sensor is operable to monitor a pressure difference across the filter. When the sensed indoor air quality or pressure different exceeds a corresponding threshold, the system determines that cleaning is necessary and may initiate a cleaning cycle. It should be understood that a cleaning operation can be performed not only when the system is in a normal mode of operation, but also when the air conditioning unit 20 is in a diagnostic mode or a standby mode of operation.

During a cleaning cycle, all or only a portion of the filter 34 may be cleaned. For example, the drive system 36 may be operable to move the filter 34 the axial length of the opening 26 such that the upper portion 34A of the filter 34 overlapping the openings 26 was not previously exposed. In such embodiments, only the portion of the filter 34 that was previously exposed will be cleaned. In other embodiments, the drive system 36 is operable to rotate the filter a full 360 degrees such that the entire filter 34 is cleaned.

Upon initiation of a cleaning cycle, the drive mechanism or motor M will rotate the at least one drive support 38a. As the filter 34 moves, the first cleaning brush 68 will brush the surface of the filter 34 to remove debris therefrom. As the filter 34 continues to move, the partially cleaned portion of the filter 34 will then be sprayed with cleaning fluid by the cleaning jet 64. The force of the cleaning fluid output from the cleaning jet 64 is sufficient to loosen and/or remove particles that are stuck to the filter 34. In embodiments where a sufficient amount of cleaning fluid is not available in reservoir 66, an alert, such as an indication to the user for example, will be generated. Further, in such embodiments, the filtration system 32 will continue to function and perform a dry cleaning operation without the use of the cleaning jet 64 until the reservoir 66 is refilled. With continued movement of the filter 34 via the drive system 36, the second cleaning brush 72 engages the wet portion of the filter 34 to dry and remove any remaining particulate matter therefrom. After having passed by the second cleaning brush 72, the corresponding portion of the filter 34 may be considered “clean.”

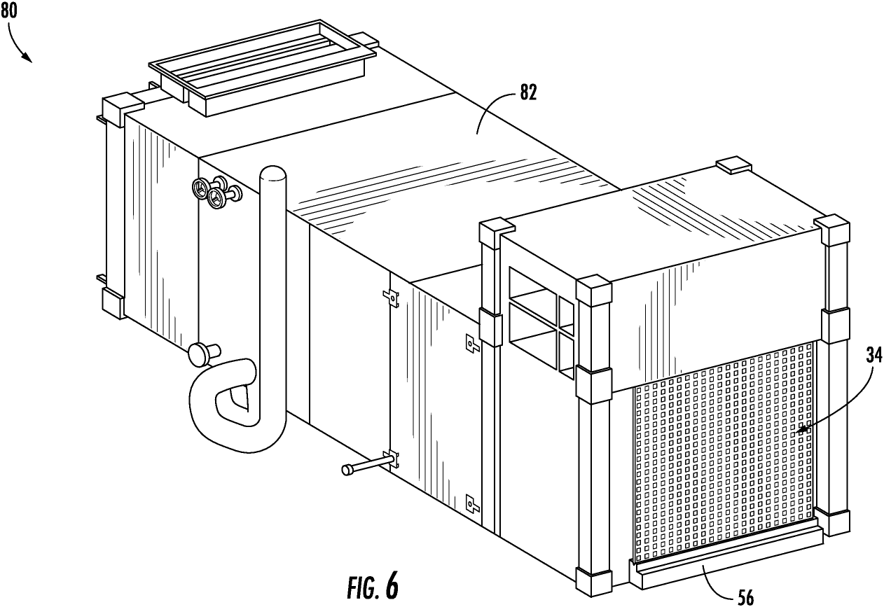

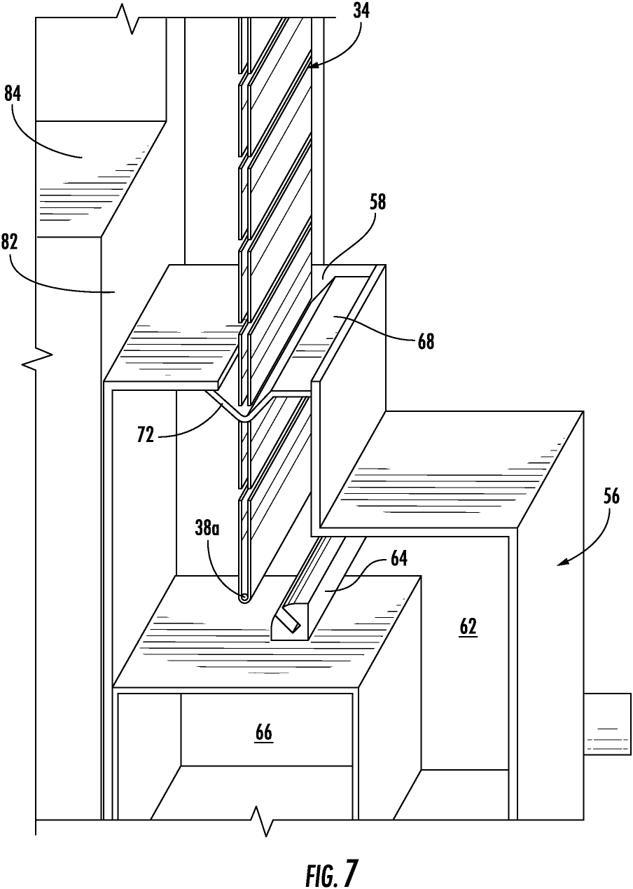

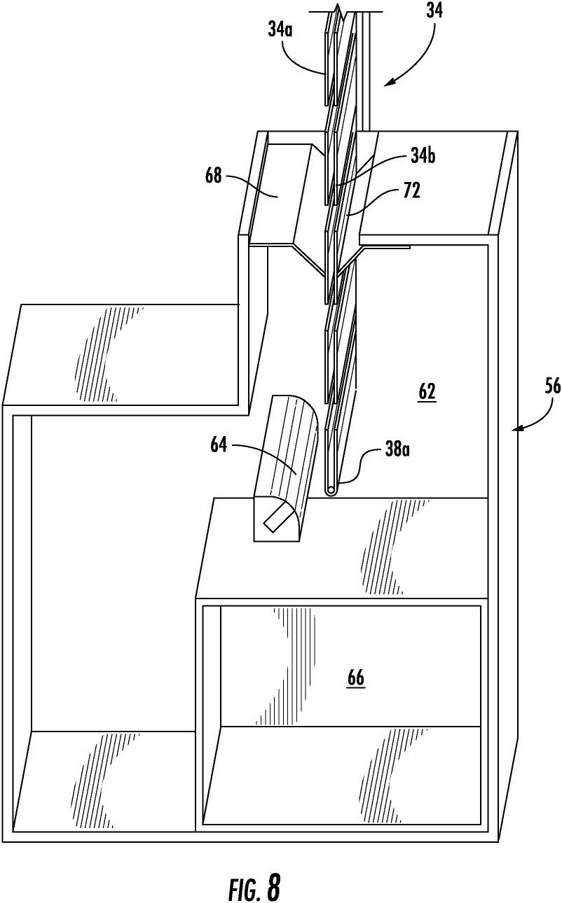

With respect to FIGS. 6-8, an example of a commercial air handling unit 80 is illustrated. In an embodiment, the air handling unit 80 includes a housing 82 and a cleanable filtration system 32 substantially identical to the system described with respect to FIGS. 1-5 mounted to the housing 82. However, as shown, the configuration of the system 32 is rotated such that air intake opening 84 and the filter 34 overlapping the opening 84 are oriented within a substantially vertical plane. In such embodiments, a plurality of supports 38 may, but need not be, arranged at a central or intermediate portion of the axial length of the filter 34. Further, the first and second cleaning brush 68, 72 may be aligned with one. However, embodiments where the first and second cleaning brushes 68, 72 remain offset from one another, such as shown in FIGS. 2-5, are also contemplated herein. Accordingly, it should be understood that a cleanable filtration system 32 as described herein may be adapted for use in any suitable configuration corresponding to an air conditioning system.

Inclusion of a cleanable filtration system 32 as described herein can extend the life of the air conditioning unit, while also improving the surrounding air quality. In addition, the cleanable filtration system 32 is compatible for use with existing HVAC equipment and therefore can be provided as a retrofit option or can be integrated within a new HVAC product.

The term “about” is intended to include the degree of error associated with measurement of the quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure is not limited to the particular embodiment disclosed as the best mode contemplated for carrying out this present disclosure, but that the present disclosure will include all embodiments falling within the scope of the claims.

What is claimed is:

1. A cleanable filtration system for an air conditioning system comprising:
a continuous filter positionable adjacent to an inlet opening in the air conditioning system;
a drive system operably coupled to the continuous filter to move the continuous filter relative to the inlet opening; and
a cleaning jet positioned to spray a cleaning fluid on an adjacent portion of the continuous filter.

2. The cleanable filtration system of claim 1, wherein the drive system further comprises:
a drive mechanism; and
at least one support operably coupled to the drive mechanism, the at least one support being mounted within an interior area defined by the continuous filter.

3. The cleanable filtration system of claim 2, wherein the at least one support is frictionally engaged with the continuous filter.

4. The cleanable filtration system of claim 2, wherein the at least one support includes a first support and a second support, and the first support is operably coupled to the drive mechanism.

5. The cleanable filtration system of claim 4, wherein the second support is a passive support.

6. The cleanable filtration system of claim 1, further comprising a housing having a hollow interior and a hole formed at a side of the housing such that the continuous filter extends through the hole, wherein the cleaning jet is positioned to spray the cleaning fluid on the continuous filter within the housing.

7. The cleanable filtration system of claim 1, further comprising a cleaning brush positioned downstream from the cleaning jet relative to a path of movement of the continuous filter, wherein the cleaning brush is arranged in engagement with a surface of the continuous filter.

8. The cleanable filtration system of claim 7, further comprising another cleaning brush positioned upstream from the cleaning jet relative to the path of movement of the continuous filter, wherein the another cleaning brush is arranged in engagement with the surface of the continuous filter.

9. The cleanable filtration system of claim 8, further comprising a housing, wherein at least one of the cleaning brush and the another cleaning brush being arranged within an interior of the housing.

10. The cleanable filtration system of claim 8, wherein the cleaning brush and the another cleaning brush are axially aligned.

11. The cleanable filtration system of claim 8, wherein the cleaning brush and the another cleaning brush are axially offset.

12. The cleanable filtration system of claim 1, wherein the continuous filter is formed from a mesh material.

13. An air conditioning system comprising:
a cabinet having an inlet opening;
a filter mounted in overlapping arrangement with the inlet opening; and
a system for automatically cleaning the filter while the filter is mounted to the cabinet.

14. The air conditioning system of claim 13, wherein the system for automatically cleaning the filter includes a housing mounted to the cabinet.

15. The air conditioning system of claim 13, wherein the filter is a continuous filter and the system for automatically cleaning the filter further comprises:
a drive system operably coupled to the continuous filter to move the continuous filter relative to the inlet opening; and
a cleaning jet positioned to spray a cleaning fluid on an adjacent portion of the continuous filter.

16. A method of operating an air conditioning system comprising:
automatically initiating a filter cleaning operation;
driving a filter of the air conditioning system along a path of movement relative to a housing of the air conditioning system while the filter is connected to the air conditioning system; and
spraying a cleaning fluid onto a portion of the filter as the filter is driven along the path of movement.

17. The method of claim 16, wherein initiating the filter cleaning operation occurs on demand.

18. The method of claim 16, wherein initiating the filter cleaning operation occurs based on a predetermined schedule.

19. The method of claim 16, wherein initiating the filter cleaning operation occurs based on a sensed parameter.

20. The method of claim 16, wherein initiating the filter cleaning operation occurs in response to one of artificial intelligence and a machine learning algorithm.
